(19) United States
(12) Patent Application Publication
(10) Pub. No.: US 2013/0206657 A1
(43) Pub. Date: Aug. 15, 2013

(54) SELF-SUSTAINED BIO-DIGESTER FOR ONBOARD DEGRADATION OF HUMAN WASTE

(71) Applicants: Dev Vrat Kamboj, Gwalior (IN); Lokendra Singh, Tezpur (IN); Vichitra Kumar Gangwar, Gwalior (IN); Rajagopalan Vijayaraghavan, Gwalior (IN)

(72) Inventors: Dev Vrat Kamboj, Gwalior (IN); Lokendra Singh, Tezpur (IN); Vichitra Kumar Gangwar, Gwalior (IN); Rajagopalan Vijayaraghavan, Gwalior (IN)

(73) Assignee: Director General, Defence Research & Development Organisation, New Delhi (IN)

(21) Appl. No.: 13/876,791

(22) PCT Filed: May 6, 2011
(86) PCT No.: PCT/IN2011/000318

§ 371 Date: Mar. 28, 2013

(30) Foreign Application Priority Data
Oct. 1, 2010 (IN) 2375/DEL/2010

(51) Int. Cl. C02F 3/30

(52) U.S. Cl. CPC C02F 3/30
USPC 210/150

(57) ABSTRACT

This invention relates to the field of human waste handling, treatment and disposal in mobile public carriers. In particular the invention is directed to a self- sustained bio-digester for onboard degradation of human waste. Said bio-digester comprising at least three components; biological treatment component, chemical treatment component; and non-biodegradable materials elimination component

### FIELD OF INVENTION

This invention relates to self-sustained bio-digester for onboard degradation of human waste. In particular the invention provides an apparatus for efficient biodegradation and chemical treatment of human waste for safe environmental disposal.

### PRIOR ART

There are various types of organic pollutants that mostly comprise of human waste (night soil), animal waste, food and chemical industry wastes. These, if discharged to aquatic bodies are subjected to decomposition by natural microbial population which consumes the dissolved oxygen of the surroundings resulting in disturbance of aquatic flora and fauna. Among these wastes, human waste is of high concern because of its aesthetic and environmental nuisance. Its deterioration starts even before it is discharged from the human body. Besides leading to organic pollution, it is a store house of pathogens and is responsible for various water borne diseases like cholera, jaundice, typhoid, etc.

Historically, humans used to defecate in open areas where it was left for drying/natural degradation. Subsequently, the human waste was physically transported to an isolated area earmarked for its natural degradation which was not only generating off odorous compounds but also polluting and contaminating the natural surroundings. With the development of civilization, researchers are continually searching for newer methods for safe disposal of human waste. At present, there are various options being practiced in different parts of the world which include physical transportation, chemical and biological treatment (U.S. Pat. No. 5,580,457). Transporting of waste from cities of high population density is a costly affair because of the high cost of land in the adjoining areas and operational cost associated if waste is removed to remote locations of low cost. This is particularly problematic if liquid waste is to be transported to the disposal site. Incineration of the waste is facing increasing public resistance due to the release of noxious gases and high costs. In general chemicals used to treat the waste do not completely degrade the human waste and as a result add to the environmental pollution.

Biodegradation is considered to be the most preferable way of treating the waste because of its self sustainability, cost effectiveness and eco-friendliness. It is carried out in two different ways: aerobically and anaerobically. Aerobic process employs bacteria which have ability to use oxygen in energy generation. Because of this ability the addition of oxygen or air to a bioreactor/digester can increase the aerobic population rapidly. This increase in population results in increased rate of biodegradation but unfortunately aerobic population becomes the sludge/pollutant. This sludge must be removed prior to discharge of treated material into the environment. Moreover, aerobic process is an energy intensive process requiring energy for aeration. On the other hand, anaerobic process employs bacteria which grow strictly in the absence of air/oxygen. These bacteria are inhibited by oxygen rich environment. Anaerobic process does not essentially require the energy for its operation and the amount of sludge generated is comparatively very less because of lower biomass produced in the absence of oxygen. The main products of anaerobic degradation include methane, carbon dioxide and hydrogen sulphide. Methane is primary component of natural gas and is readily combustible and thus can be burnt to produce energy without posing any significant environmental hazards. Moreover, anaerobic processes are known to inactivate the pathogens present in the human waste.

There are two kinds of human waste treatment systems. In the first kind all residences, businesses and institutions in a municipality are connected through a network of sanitary sewers to a central sewage treatment plant. The second kind is the septic tank system mostly installed for single family where usually connection to a sewer is not available. However, there is no system/apparatus available which can be used for human waste treatment in public carriers like train, bus, boat, aeroplane, etc. for on-site treatment. The only option in these public transports is to collect the waste in a closed container and to transport it to the site of treatment. To avoid the foul smell at the site of collection, chemicals are added to the collection containers which ultimately delay/retard the biodegradation process but create the problem at the site of biological treatment. In other words, this approach requires man power, infrastructure and money for disposal of human waste generated in the public transport vehicles. Indian railway is the biggest public carrier in the world. Presently there is no provision for storage collection and transportation of human waste and its subsequent treatment. Human waste generated during journey in the toilets is discharged on the rail tracks, thus creating aesthetic nuisance, foul smell, breeding place for insects and also the risk of various diseases because of presence of pathogens. The situation is even more precarious at railway stations.

Two patents in Indian Patent Office have been filed (patent filing no. 1595/DEL/2006 and 1411/DEL/2007) for biochemical treatment of human waste generated onboard. The system involves an instrument for anaerobic biodegradation of organic waste and chlorination of the effluent before final discharge. In the first patent, the instrument has the provision for connection with two toilets. Public transport systems like buses are bound to have only one toilet and the present system having provision for connection with two toilets is not suitable. Moreover, there will also be a space constraint for housing such big instrument beneath the public transport system. Besides, there are difficulties in the installation of a heavy and big digester under the public transport system. These problems were addressed in the second patent (patent filing no.: 1411/DEL/2007) which demonstrates a light weight instrument having provision for connection with single toilet only. This instrument suffered with drawback of occasional chocking by non-biodegradable materials like water bottles, tea cups, food packaging materials, etc. by unaware commuters as there is no provision to prevent their entry inside the instrument. This problem was alleviated in the design of present instrument which does not allow these non-biodegradable materials to enter inside, thereby decreasing the maintenance frequency and cost of operation.

Therefore, there is a need of an apparatus that has the provision to prevent the entry of non-biodegradable materials like water bottles, tea cups, food packaging materials, etc and can still perform the biodegradation of human waste for its safe disposal.

### OBJECTS OF PRESENT INVENTION

The primary objective of the present invention is to provide a human waste handling, treatment and disposal system in mobile public carriers.

Another object of the present invention is to provide a biodigester for human waste handling, treatment and disposal in mobile public carriers.

Another object of the present invention is to design the self sustainable biodigester, i.e., the digester does not require any external energy for its operation.

Another object of the present invention is to provide a biodigester capable of degrading the human waste anaerobically.

Yet another object is to provide a biodigester which can convert the human waste into odourless and colourless gases.

Another object of the present invention is to provide a bio-digester for human waste treatment wherein repeated addition of bacteria are not required and one time addition of the inoculum is sufficient.

Another object of the present invention is to provide a matrix for immobilization of bacteria for maintaining them at high concentration for fast biodegradation.

Yet another object is to provide the biodegrading surface for bacterial attachment so that the bio-digester can withstand washout of bacteria during excessive use of water.

Another object of the present invention is to prevent the entry of non-biodegradable materials into the bio-digester and minimize the chocking problem.

Another object is to do chlorination of the biologically treated waste to make it free from foul smelling compounds and pathogenic microorganisms.

Another objective is to fix a chlorinator outside the main tank to provide more space for biodegradation.

Yet another object is to provide the chlorinator where chlorine tablets can be easily inserted in the chlorinator for disinfection of the discharged waste.

Still another object is to provide a n easy to use, maintain and cost-effective bio-digester.

Yet another objective is to modify the system of the bio-digester to suit the working of maintenance staff of the rail coach.

Yet another objective is to make the bio-digester light weight and small in dimensions which can be fitted onto a public transport vehicle without affecting the sitting capacity of the vehicle.

Yet another objective is to make it useful for connection with single toilet.

Further object of the present invention is to provide digester which is long lasting and resistant to the jerks and various environmental conditions.

### SUMMARY OF INVENTION

In order to obviate the drawbacks of the prior art and to achieve the aforesaid objects, the present invention provides a self sustainable bio-digester for human waste handling, treatment and disposal.

The said bio-digester for onboard degradation of human waste for use in single toilet comprising at least three components comprising at least three components;
biological treatment component,
chemical treatment component; and
non-biodegradable materials elimination component;
wherein,
the biological treatment component comprises a housing; said housing having at least six chambers separated by partitions providing an anaerobic chamber having the long path and time for biological treatment;
a chlorination chamber fixed outside the housing; said chlorination chamber having hinged cap for stacking the chlorine tablets inside a retrievable cylinder allowing only one tablet to come in contact with the effluent;
a junction box at the top of the bio-digester housing and connecting the bio-digester with the toilet for excluding non-biodegradable materials; said box comprises of steel rods fixed at an angle of 30° from the horizontal for sliding the non-biodegradable material out of the box through a guide projected out of box,
said bio-digester has an immobilization matrix in the form of PVC on partitions, bottom and sides for attachment of bacteria to prevent washout, having higher cell mass for enhanced fermentation, better tolerance of bacteria for adverse environmental conditions and to have better baffling.
a series of pipes connecting the chambers and units in the bio-digester;

The bio-digester is further comprises:
at least one socket in the middle of first chamber for removal of residual solids, small non-biodegradable materials and cleaning; and another in the middle of sixth chamber for removal of the settled residual sludge;
at least two inbuilt stainless steel supports hooks on either sides of the bio-digester for fixing the bio-digester.

The present digester provides continuous degradation of human waste by anaerobic bacteria at mesophilic and low temperature. The bio-digester is box shape, made of 3 mm thick stainless steel (SS). The box structure is almost rectangular with 1100-1150 mm length, 675-700 mm width and 480-510 mm height (FIG. 1). Two slopes are provided on the left bottom and the right top corners of the tank for easy access by the rail coach staff for maintenance of other coach components. The bio-digester has six chambers, 1-6 (FIG. 2) separated by stainless steel partitions of height almost equal to that of bio-digester. The waste from the toilet enters to chamber ‘1’ through inlet pipe ‘7’ (75-125 mm diameter) where biological treatment is initiated. Polyvinyl chloride (PVC) sheets attached on side walls, bottom and both sides of intermediary partitions serve as immobilization matrix for anaerobic microbial consortium to resist the washouts of culture and for better tolerance of microorganisms for adverse conditions like extremes of pH, volatile fatty acids (VFA) and temperature. The bacteria immobilized to PVC and settled in the sediments throughout the length and width of the tank provides additional bacterial mass (other than suspended bacteria) for faster biodegradation of the waste. Further, this additional biomass provides the necessary bacterial inoculums if same is washed out in case of excess use of water by passengers or during maintenance. Excess bacterial mass also aids in fermentation at low temperature as the performance of entrapped bacteria has been proved better than the suspension in the extreme conditions. Further, inoculum having ability to function in broader temperature range also takes care of fermentation at low temperature. The fermenting waste flows from chamber ‘1’ to ‘2’ through a pipe (100 mm in diameter) ‘19’ (FIG. 4) which starts 50-100 mm from bottom of ‘A’ and opens at a height of 350-400 mm in chamber ‘2’. Pipe in chamber ‘1’ is covered by a sieve containing holes (625 mm²) throughout the depth and height of chamber ‘1’. Waste from chamber ‘2’ flows through a vertical slit (100 mm wide) to chamber ‘3’, ‘4’ and ‘5’. From chamber ‘5’, the fermenting liquid enters to chamber ‘6’ through a pipe ‘19’ as arranged in chamber ‘1’. The fermented waste goes out of chamber ‘6’ through a pipe ‘8’ (FIG. 1) which starts at 250 mm height at the right side of chamber wall ‘F’ and enters to chlorinator ‘9’ at 50 mm height. The partitions provided in the main tank also take care of splashing of liquid during sudden change in the momentum of the train. Chlorinator is a rectangular box closed from top with a hinged cap for putting the chlorine tablets and is placed outside the main bio-digester. The chlorinator dimensions are: 90-110 mm length, 90-110 mm width, 250-300 mm height. Waste from chamber ‘6’ enters to the chlorinator through pipe ‘8’ of 50-75 mm diameter and leaves the chlorinator through pipe ‘16’ (50-65 mm diameter) at height of 50 mm. An arrangement has been made for stacking the chlorine tablets in the chlorinator in a cylindrical (80-90 mm diameter) mesh (mesh size: 100 mm²).

For preventing the entry of non-biodegradable materials like bottles, tea cups, etc., a rectangular box (10) (FIG. 1) of 250 mm length, 200 mm width and 150 mm height is provided on top of the bio-digester. It acts as interface between pipe (150 mm diameter) coming from the toilet and the inlet pipe ‘7’ of the bio-digester. The box has stainless steel rods (5 mm diameter) at a distance of 25 mm throughout the hole at the bottom of the box (11, FIG. 2). Rods are fixed at an angle of 30° from the horizontal for sliding the non-biodegradable material out of the box through a guide ‘12’ (FIG. 1) projected out of box, thereby preventing the entry into the bio-digester.

A socket ‘13’ (FIG. 1) of 150-175 mm diameter is provided in the middle of chamber ‘1’ at a height of 50-60 mm from the bottom and another socket ‘14’ (FIG. 1) of 60-70 mm diameter in chamber ‘6’ at the bottom. The bio-digester is also provided with two inbuilt stainless steel supports ‘O’ (FIG. 1) culminating into two hooks on either side of the bio-digester. These hooks are used for fixing the bio-digester under the rail coach.

Polyvinyl chloride (PVC) sheets attached on side walls, bottom and both sides of intermediary partitions serve as immobilization matrix for anaerobic microbial consortium to resist the washouts of culture and for better tolerance of microorganisms for adverse conditions like extremes of pH, volatile fatty acids (VFA) and temperature.

The said bio-digester of the present invention provides continuous degradation of human waste by anaerobic bacteria at ambient temperature.

It is made of stainless steel which is near rectangular in shape containing suitable slopes at the top right and bottom left sides for accessing the other coach parts by the maintenance staff. The tank is to be fitted beneath the toilet under slung. The bio-digester has six chambers, the walls of which are covered with polyvinylchloride (PVC) sheets for enhanced biodegradation of human waste as PVC has the ability to immobilize the bacteria, prevent washouts and resist adverse environmental conditions. The fermented waste enters the chlorination chamber fixed outside the main bio-digester before final discharge in the environment so that residual pathogens are inactivated. A small rectangular junction box is provided on top of the bio-digester tank with provision to exclude non-biodegradable materials.

### DESCRIPTION OF FIGURES

FIG. 1: Isometric wired view of bio-digester.

FIG. 2: Top wired view of bio-digester.

FIG. 3: Internal partitions of bio-digester.

FIG. 4: Top wired view of second embodiment of bio-digester.

FIG. 5: Front wired view of the bio-digester

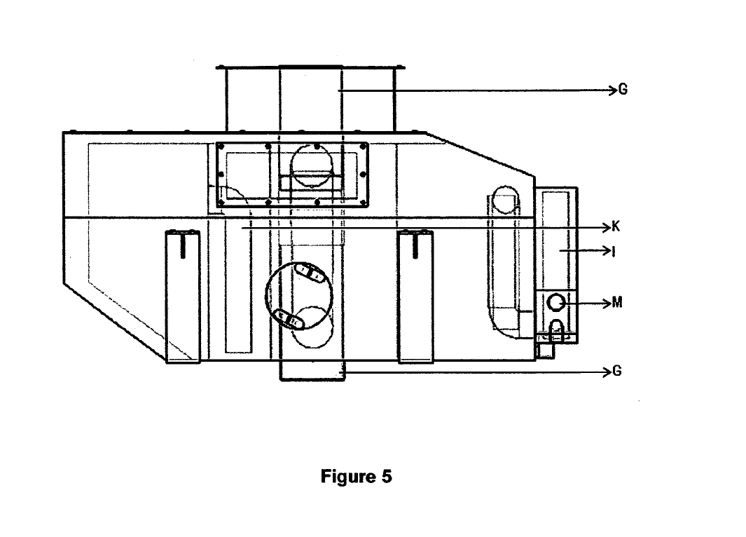

FIG. 6: Side wired view of the bio-digester

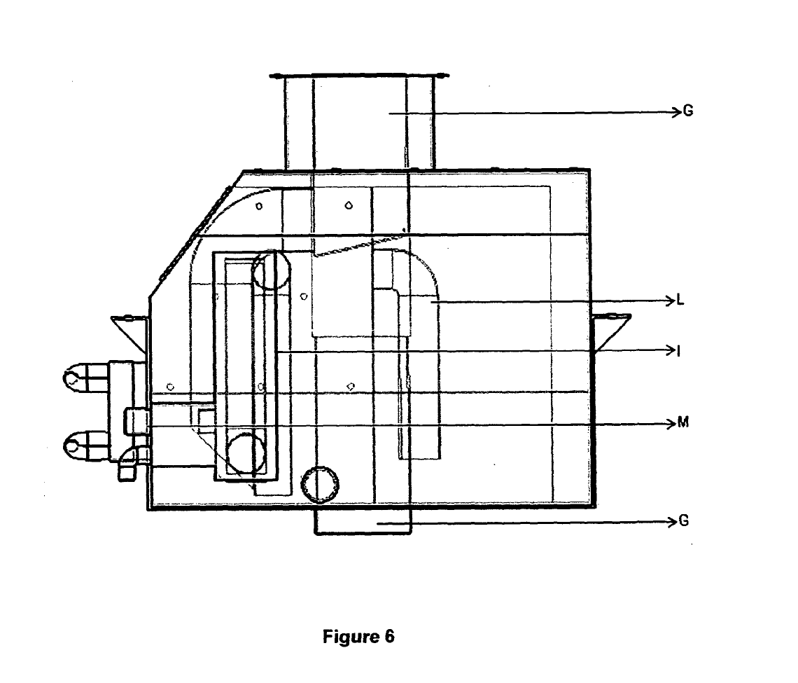

### DETAILED DESCRIPTION OF THE INVENTION

The present digester provides continuous degradation of human waste by anaerobic bacteria at mesophilic temperature.

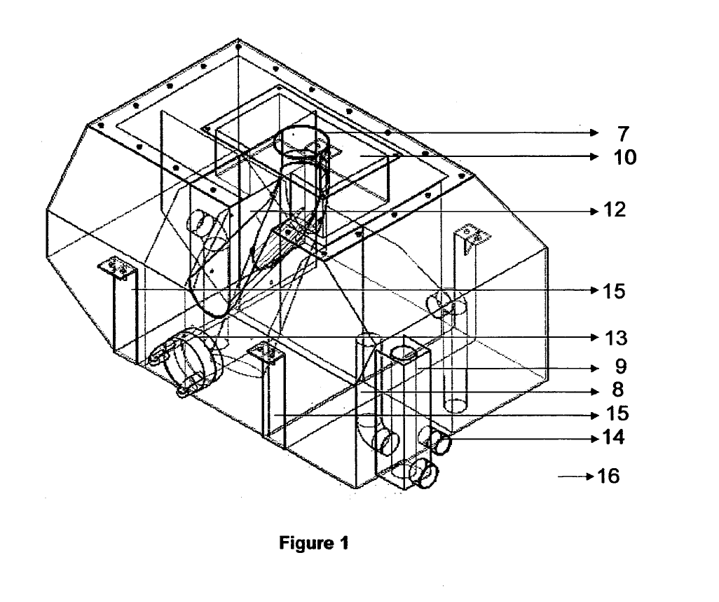

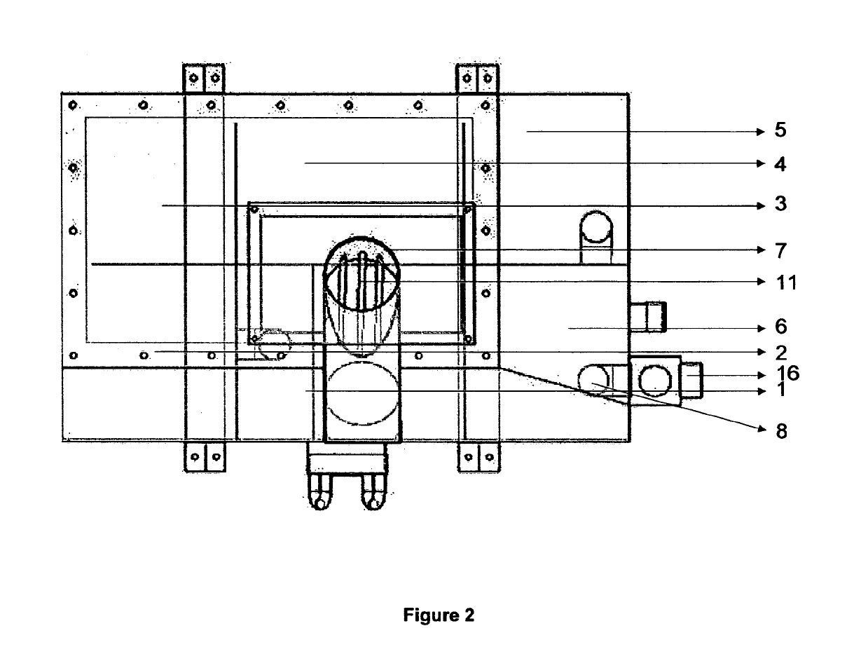

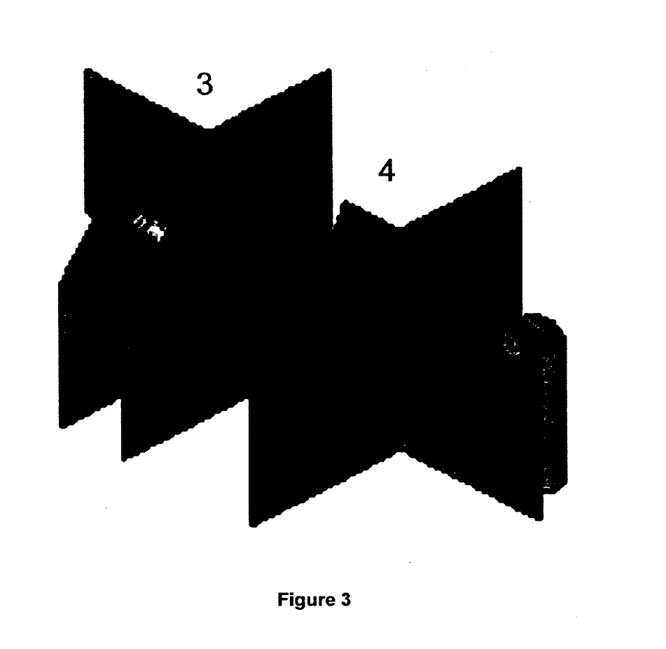

The bio-digester of the present comprises box shape housing, made of about 3 mm thick stainless steel (SS). The box structure is almost rectangular with about 1100-1150 mm length, 675-700 mm width and 480-510 mm height (FIG. 1). Two slopes are provided on the left bottom and the right top corners of the tank for easy access by the rail coach staff for maintenance of other coach components. The bio-digester has six chambers 1 to 6 (, FIG. 2, FIG. 3) separated by stainless steel partitions of height almost equal to that of bio-digester.

The waste from the toilet enters to chamber ‘1’ through inlet pipe ‘7’ (75-125 mm diameter) (FIG. 2) where biological treatment is initiated. Polyvinyl chloride (PVC) sheets attached on side walls, bottom and both sides of intermediary partitions serve as immobilization matrix for anaerobic microbial consortium to resist the washouts of culture and for better tolerance of microorganisms for adverse conditions like extremes of pH, volatile fatty acids (VFA) and temperature. The fermenting waste flows from chamber ‘1’ to ‘2’ through a pipe (100 mm in diameter) which starts 150 mm from bottom of ‘1’ and opens at a height of 350-400 mm in chamber ‘2’. Pipe in chamber ‘1’ is covered by a sieve containing holes (625 mm²) throughout the depth and height of chamber ‘1’ (FIG. 3). Waste from chamber ‘2’ flows through a slit (100 mm wide) to chamber ‘3’, ‘4’ and ‘5’. From chamber ‘5’, the fermenting liquid enters to chamber ‘F’ through a pipe as arranged in chamber ‘1’. The fermented waste goes out of chamber ‘6’ through a pipe ‘8’ (FIG. 1) which starts at 250 mm height at the right side of chamber wall ‘6’ and enters to chlorinator ‘9’ (FIG. 1) at 50 mm height. Chlorinator is a rectangular box closed from top with a hinged cap for putting the chlorine tablets and is placed outside the main bio-digester. The chlorinator dimensions are: 90-110 mm length, 90-110 mm width, 250-300 mm height. Waste from chamber ‘6’ enters to the chlorinator through pipe ‘8’ of 50-75 mm diameter and leaves the chlorinator through pipe ‘16’ (50-75 mm diameter) at height of 50 mm. Pipe ‘8’ and ‘16’ open in the chlorinator at almost the same height and opposite to each other. The arrangement has been made for stacking the chlorine tablets in 80-90 mm diameter cylindrical mesh (mesh size: 100 mm²).

In one of the embodiment, for preventing the entry of non-biodegradable materials like bottles, tea cups, etc., a rectangular box 10 (FIG. 1) of 250 mm length, 200 mm width and 150 mm height is provided on top of the bio-digester. It acts as interface between pipe (150 mm diameter) coming from the toilet and the inlet pipe ‘7’ of the bio-digester. The box has stainless steel rods (5 mm diameter) at a distance of 25 mm throughout the hole at the bottom of the box 11 (FIG. 2). Rods are fixed at an angle of 30° from the horizontal for sliding the non-biodegradable material out of the box through a guide ‘12’ (FIG. 1) projected out of box, thereby preventing the entry into the bio-digester.

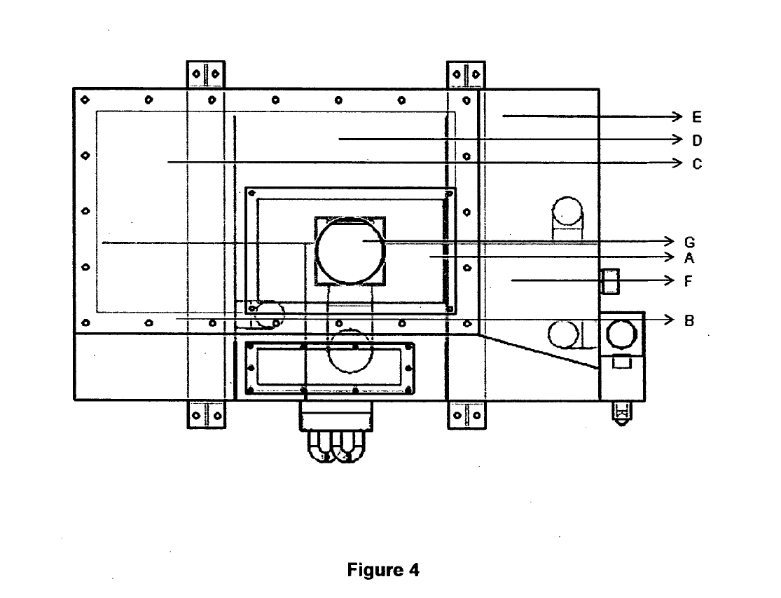

In another embodiment for preventing the entry of non-biodegradable materials like bottles, tea cups, etc., a rectangular box ‘10’ (FIG. 1) of 250 mm length, 200 mm width and 150 mm height is provided on top of the bio-digester with a slider valve. It also acts as interface between pipe (150 mm diameter) coming from the toilet and the inlet pipe ‘7’ of the bio-digester. The pipe ‘7’ spans the entire height of biodigester and opens in the bottom of the biodigester for dispensing the non biodegradable material which does not find entry into the biodigester (FIG. 4, 5). A curved pipe 17′ of 90-110 mm diameter comes out from the inlet pipe ‘7’ and enters into the chamber ‘1’ of the biodigester (FIG. 1). The pipe has stainless steel vertical rods (5 mm diameter) at a distance of 20 mm throughout the hole at the junction of inlet pipe ‘7’ for preventing the entry of larger size non-biodegradable material inside the biodigester. At the junction of pipes ‘17’ and ‘7’ a slider valve is also provided for holding the non-biodegradable material until one cycle of flush water is complete. After the completion of the flush cycle, the night soil enters the pipe ‘17’ and the remaining non-biodegradable larger size material is thrown out by opening of the slider valve in pipe ‘7’ which has been synchronized with the flush cycle.

A socket ‘13’ (FIG. 1) of 150-175 mm diameter is provided in the middle of chamber ‘1’ at a height of 50-60 mm from the bottom and another socket ‘14’ (FIG. 1) of 60-70 mm diameter in chamber ‘6’ at the bottom. The bio-digester is also provided with two inbuilt stainless steel supports ‘15’ (FIG. 1) culminating into two hooks on either side of the bio-digester. These hooks are used for fixing the bio-digester under the rail coach.

An apparatus for onboard treatment of human waste for railways, buses and other public transport systems for converting it into the effluent which is odourless, free from pathogens and does not create any aesthetic nuisance.

An apparatus for onsite treatment of human waste avoiding the need for its transportation to the site of treatment.

1. The self sustained bio-digester for onboard degradation of human waste for use in single toilet comprising at least three components;
biological treatment component,
chemical treatment component; and
non-biodegradable materials elimination component; wherein,
the biological treatment component comprises a housing; said housing having at least six chambers separated by partitions providing an anaerobic chamber having the long path and time for biological treatment;
a chlorination chamber fixed outside the housing; said chlorination chamber having hinged cap for stacking the chlorine tablets inside a retrievable cylinder allowing only one tablet to come in contact with the effluent;
a junction box at the top of the bio-digester housing and connecting the bio-digester with the toilet for excluding non-biodegradable materials; said box comprises of steel rods fixed at an angle of 30° from the horizontal for sliding the non-biodegradable material out of the box through a guide projected out of box;
said bio-digester has an immobilization matrix in the form of PVC on partitions, bottom and sides for attachment of bacteria to prevent washout, having higher cell mass for enhanced fermentation, better tolerance of bacteria for adverse environmental conditions and to have better baffling;
a series of pipes connecting the chambers and units in the bio-digester.

2-13. (canceled)

14. The bio-digester as claimed in claim 1, wherein the pipe in first chamber is covered by a sieve throughout the depth and height of first chamber.

15. The bio-digester as claimed in claim 1, wherein the waste from second chamber flows through a slit to chamber third, fourth and fifth.

16. The bio-digester as claimed in claim 1, wherein waste enters from fifth chamber, to sixth chamber through a pipe as arranged in first chamber.

17. The bio-digester as claimed in claim 1, wherein the fermented waste goes out of sixth chamber through a pipe ‘8’ at the right side of sixth chamber wall and enters to chlorinator.

18. The bio-digester as claimed in claim 1, wherein the waste leaves the chlorinator through pipe ‘16’.

19. The bio-digester as claimed in claim 1, wherein pipes ‘8’ and ‘16’ open in the chlorinator at almost the same height and opposite to each other.

20. The bio-digester as claimed in claim 1, wherein the junction box of the bio-digester may optionally comprise curved pipe connecting the inlet pipe and chamber and having vertical rods through our the hole at the junction of the inlet pipe.

21. The bio-digester as claimed in claim 20, wherein a slider valve is provided at the junction of the curved pipe and the inlet pipe.

22. The bio-digester as claimed in claim 1, wherein the bio-digester further comprises at least one socket in the middle of first chamber for removal of residual solids, small non-biodegradable materials and cleaning; and another in the middle of sixth chamber for removal of the settled residual sludge.

23. The bio-digester as claimed in claim 1, wherein the bio-digester further comprises at least two inbuilt stainless steel supports hooks on either sides of the bio-digester for fixing the bio-digester.

24. The bio-digester as claimed in claim 1, wherein the submerged inlet pipes prevent the entry of foul smelling gases from the head space to the toilet.

25. The bio-digester as claimed in claim 1, wherein the maintenance window on the side of fermentation chamber removes sludge and helps in maintenance.

26. The bio-digester for onboard degradation of human waste comprising at least three components substantially as herein described with reference to the foregoing description and embodiments.
